(19) United States
(12) Patent Application Publication
(10) Pub. No.: US 2007/0250439 A1
(43) Pub. Date: Oct. 25, 2007

(54) Loan Lock Options

(76) Inventor: Greg H. Crocker, Sanford, FL (US)

Correspondence Address: PETER K. TRZYNA, ESQ., P O BOX 7131, CHICAGO, IL, 60680, US

(21) Appl. No.: 10/575,995

(22) PCT Filed: Jun. 13, 2005
(86) PCT No.: PCT/US05/20784

§ 371 Date: May 11, 2007

(51) Int. Cl. G06Q 40/00

(52) U.S. Cl. 705/38

(57) ABSTRACT

The disclosure relates to computer-implemented options that can be negotiated between two parties, addressing a financial term of a transaction, which financial term is subject to change before it becomes a fixed obligation of the parties. Disclosed embodiments implementing the options include a template for associating data indicating a desired price lock with data indicating a customer identity; a data structure; a database recorded on a computer readable medium; a programmed computer system; a self-executing option agreement; a method or machine for establishing a price lock for a future transaction; methods for calculating and hedging risk exposure resulting from accepting a portfolio of such options; and a computer-aided method for producing an asset-backed security backed by a multiplicity of loans.

### RELATED APPLICATIONS

Priority is claimed under 35 U.S.C. § 120 to U.S. Ser. No. 10/867,520, filed Jun. 13, 2004, now pending. The above-cited application is hereby incorporated here by reference in its entirety to provide continuity of disclosure.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

[Not Applicable]

### BRIEF SUMMARY OF THE INVENTION

[Not Applicable]

### BRIEF DESCRIPTION OF SEVERAL VIEWS OF THE DRAWINGS

FIG. 1 is a schematic view showing one embodiment of the apparatus, parties, and method steps potentially involved in a multi-level mortgage loan transaction.

FIG. 2 is a schematic view of one embodiment of a suitable data structure useful for storing rate lock portfolio information in a form that minimizes the number of calculations needed to manage a heterogeneous portfolio.

FIG. 3 is a schematic view showing one embodiment of a method for updating a portfolio of rate lock agreements to determine whether the rate locks have been triggered by market conditions.

FIG. 4 is a schematic view showing one embodiment of a method for hedge updating.

FIG. 5 is a schematic view showing one embodiment of a method for opportunity updating.

FIG. 6 is a schematic view showing one embodiment of a method for price opportunity updating.

### DETAILED DESCRIPTION

This specification relates to computer-implemented options between two parties, addressing a financial term of a transaction, which financial term is subject to change before it becomes a fixed obligation of the parties.

The two parties can be, but are not limited to, a borrower and a lender or a buyer and seller at any level in a transaction. The parties are sometimes referred to as an “offeror” and an “offeree,” based on who is offering and who is accepting the option. As between two parties, either one can be the offeror or the offeree, although conventionally the offeror is the seller or lender and the offeree is the buyer or borrower. The financial term can be, but is not limited to, the interest rate of a transaction. The transaction can be, but is not limited to, a loan. The change in the financial term can be, but is not limited to, a change in the market rate of the financial term. The delay before the financial term becomes a fixed obligation of the parties can be, but is not limited to, the time between the presentation of a loan application and the date the loan closes.

One non-limiting example is an option granted by a lender to a prospective borrower on the interest rate of a mortgage loan to allow the interest rate to “float” at the prevailing market rate unless and until the market rate reaches a predetermined value or “strike price,” and if that happens fixing the rate at the strike price. The strike price can be below the market rate prevailing at the time the option is granted, which is known as minimum price or a floor. The strike price can be above the market rate prevailing at the time the option is granted, which is known as a maximum price or a ceiling. There can be a floor option, a ceiling option, or both with the options having sequential or overlapping existences. The options can be created simultaneously or sequentially.

Types of Options

A first type of option is provided to the customer by, for example, a mortgage broker to give the customer an option to lock in a mortgage rate if the prevailing rate rises or falls to a corresponding predetermined value while the loan is pending. The option can be a maximum rate or ceiling above the rate prevailing at the time the lock option was set up, in which case it protects the buyer against the risk the interest rate will exceed a set value. Another contemplated option can be a minimum rate below the rate prevailing at the time the lock option was set up, which is sufficiently desirable that the buyer would accept the rate. Another contemplated option can be a combination of the above two options, having more than one strike price. For example, a butterfly option or option spread can have two strike prices—a floor and a ceiling—and the option is executed the first time the market price reaches one of the two strike prices. Thus, if the butterfly option is set while the market rate is 5% interest, and the option has a floor of 4% and a ceiling of 6%, the option is not triggered while the market rate floats, or moves, in a range above 4% and below 6%. If this range is maintained at the time the loan closes, the option has not been executed and the offeree is entitled to close the loan at the current market rate, which again is between 4% and 6%. If the market rate reaches 4% before reaching 6%, the option is triggered and the offeree is entitled to close the loan at 4% regardless of further movement of the interest rate in either direction. Conversely, if the interest rate soars to 6% and perhaps beyond, the offeree is entitled to close the loan at 6% regardless of further movement of the interest rate.

A sequence of options can be provided, such as a first option that is executed at a first strike price, followed by a second option that replaces the first option and is executed if the market price moves further to a second strike price, possibly followed by additional options. An example is a downward-trending stairstep series of options with strike prices at floors of 4.5%, 4.25%, and 4%, established when the initial market rate was 5%. If the market price reaches 4.5%, the first stairstep option triggers or executes, and the offeree is entitled to close a loan at 4.5%. If after the execution of the first option the market rate further moves to 4.25%, the second stairstep option triggers or executes, and the offeree is entitle to close the loan at 4.25%. Similarly, if the market rate then further moves to 4%, the third option is triggered and the offeree is entitled to close the loan at 4%. Upwardly trending steps are also contemplated, in another embodiment.

The price of the transaction can also be different from the measuring price used to establish the strike price for the option. For example, an option can be set up to use as the measuring price a long-term treasury bill interest rate, and as the price of the transaction the interest rate on a home mortgage loan. The option can be, for example, that if the treasury bill interest rate reaches a strike price of 5%, the loan will be closed at 5.5%.

A method is thus contemplated for establishing a price lock for a future transaction subject to market price fluctuations, the method comprising establishing a future lock-triggering price and a lock price for the transaction, wherein the lock price is the same as or different from the future lock-triggering price; agreeing, as between a lender and borrower or other offeror and offeree, that if in the future the market price for the transaction reaches the future lock-triggering price, the price for the transaction shall be the lock price.

Any of the presently disclosed options can be configured as a self-executing price lock agreement usable by a buyer and seller to establish the price of a future transaction that has a fluctuating market price, comprising a provision specifying a future lock-triggering price for the transaction, and a provision that the seller automatically agrees to accept the specified future lock-triggering price as the negotiated price of the future transaction, if in the future the market price reaches the future lock-triggering price.

Note that although the option approach can differ from a float down, it does not preclude a float down and can indeed supplement it. A float down is a lock in that is open ended for a subsequent, one time communication from a borrower to “relock” the rate. To do this essentially one time relock, the borrower must monitor the rates. But rates can move in a moment, every day, or whatever period the lender sets, so the borrower must try to constantly watch the rate, decide what future movement of the market is most likely, and then commit to re-lock the option when the time is favorable. In contrast, an embodiment herein permits the borrower to obtain an option or spread and leave the lock transaction to be automatically implemented. Subsequently, depending on the implementation, the lock could comprise a subsequent float down. Another approach can include the borrower surrendering the lock in taking another option position.

One optional feature of the price lock agreement is that it can fix the price at which the transaction will take place, but does not necessarily obligate the offeree to close the transaction (although an option that is mandatory, or mandatory upon one or more specified contingencies, on both parties once executed is another contemplated alternative). In essence, it may bind the offeror, such as a mortgage lender, to offer the locked rate if the offeree, such as a borrower, decides to close the transaction. The borrower, however, may be entitled to cancel the transaction, enter into a different transaction with the original lender, negotiate the same transaction with another lender, or may have other rights to proceed without closing the offered transaction with the executed option.

The rate lock agreement may be between any two or more parties in a transaction or series of associated transactions. The same transactions, carried out between the mortgage broker and the originating lender, allow the mortgage broker to hedge a promise made to the borrower or customer to provide an interest rate no higher than a certain value. Again, a maximum option, a minimum option, or an option spread can be provided. In a transaction at this level, for example, the mortgage broker can cap the upside risk of an interest rate rise, by buying a maximum option, while leaving the downside risk uncovered so the cost of the loan to the broker can go substantially below the guaranteed value, allowing the broker to profit from the spread between the low interest rate prevailing at closing and the rate guaranteed to the borrower. Or, to lower the cost of the option and to give the customer some benefit from a drop in interest rates, the broker can purchase both minimum and maximum rate lock options, covering the party that otherwise would lose money (or drop out of the transaction) if the interest rate changed substantially while the loan was pending.

Another contemplated type of option is an option by the offeree to substitute a different product for the initially agreed product, if the strike price is met. For example, a borrower for a mortgage loan may initially apply for a variable rate mortgage, but have the option to accept a fixed rate mortgage if the market interest rate goes down sufficiently that the borrower can afford a fixed rate mortgage loan.

Yet another contemplated type of option that might be reached is a refinancing option. At the time of closing a first mortgage loan, or at a time subsequent, the borrower may want to purchase the option to refinance the loan at a lower interest rate in the future, should the interest rate drop to a more favorable level. The option could be set up so the option is triggered and the borrower is notified automatically if the market interest rate or other measure reaches the strike price, and is then given the option to refinance at that price, notwithstanding any further movements in the market interest rate. Because refinancing generally is carried out by paying off one loan and closing another, this would not need to be a term of either mortgage loan per se; it could be an independent option to accept the second loan if the strike price is reached.

Another type of option contemplated here is an option, optionally arranged in advance of a loan transaction, for the borrower to accept a home equity loan at a certain interest rate within a certain time in the future, if interest rates drop to a certain level. In an embodiment, such an option might be made subject to the additional condition that the borrower must qualify for the loan at the time the option is executed, as by having sufficient equity in the home, a good credit history, etc.

Other non-price triggers can be used for a lock in option too. For example, offerees can indicate by means of the option approach that they would lock in a new product that is Sharia compliant for single family dwellings, should such a product be offered.

Another contemplated option can include a mortgage broker using an option to hold a debt/income rate for a future applicant, and to hold the lock option without a customer loan application yet pending.

Another location for applying an option approach is as between any upstream and any downstream party, even skipping a potentially intermediate party, e.g., an option between a lender and an investor, as discussed further below. Further, different parties in any transaction can use respective options. For example, a mortgage broker option position can be set up in the same transaction in which a customer sets up an option position. The mortgage broker can use an option position corresponding to a premium, and the customer can use an option corresponding to interest rate, for example. In some situations, broker or lender compensation must be disclosed to the customer.

The option can be analogous to a put, call, or both (i.e., a “butterfly spread”) in security trading. However, in the option context of a mortgage or other loan, differences and consequences flow from the present context, e.g., an option for yield spread premium on an interest rate lock. Also in contrast, depending on the embodiment, the recipient of the option can specify parameters such as the option floor, ceiling, etc. and even both or other mortgage features all in the same instrument or “instrument package.” For an embodiment herein, it is not necessary that the borrower or offeree go through with the transaction, which is another difference from the kind of options exercised in the securities market. Other differences exist as well, e.g., regulatory differences, etc.

Another optional difference, again depending on the embodiment, can be to allow the respective offeree to set its own criteria or ranges for the option (alternatively, terms of the option can be developed by the offeror). Typical securities options have fixed criteria. For example, an applicant could set up an essentially open-ended time period for an option, such as the point where a refinancing makes sense. What makes sense may change as the loan is repaid, for example, so a formulaic option structure can also be handled by computer.

Returning now to the situation in which the rate lock relates to a pending loan transaction arranged by a broker, the amount that a lender will pay to purchase a loan originated by a broker depends on the interest rate of the loan and the “par rate” set by the lender. The par rate is defined as the interest rate at which the lender will purchase the loan for a price equal to the face value of the loan. A lender will pay a broker $100,000, for example, to purchase a $100,000 loan originated at the par rate. Lenders will pay a premium above face value for a loan originated with an above par interest rate. The premium is called the “yield spread premium” (YSP). The YSP often represents a major part of the compensation earned by brokers in connection with the origination of a loan.

Points are set by the lender to compensate for a loan that is closed at less than the par rate. Loans closed at or above par rate will be bought by the correspondent lender at a premium price, as they are more valuable. The premium is retained by the broker, and the borrower gets the par value of the loan. Loans closed at a below-par rate will be bought by the correspondent lender at a discount. The discount is recovered by remitting to the borrower less than the nominal amount of the loan, and requiring the borrower to remit the difference by paying points to bring the loan amount up to par and thus provide the needed amount of money to the seller.

Because points in particular are a counterweight to a sub-normal interest rate, the Annual Percentage Rate (APR), as calculated in disclosure forms, has the points blended into it. Interest rate plus points can be thought of together as the price of the loan, apart from direct fees.

However, another product contemplated here is an option on a combination of interest rate and points, or interest rate, points, and fees, because there is effectively a market rate for the overall cost of a mortgage, though it is not the subject of an established secondary market at present. One option combining an interest rate lock option with options on points or fees can be arranged by providing a conversion factor to equate the number of points/amount of fees with an incremental amount of interest. For example, if the market interest rate is 6%, one point is equated to a ⅛% interest rate, and $1,000 of origination, appraisal, and other front-end fees is equated to a ¼% interest rate, the option could be for a ceiling of 6¾% on the combination of interest rate, points, and fees. Then the ceiling would be met by 6¾% interest with no points or fees, or 6⅜% interest plus 1 point and $1000 fees.

Another approach is to initially sell the customer or other offeree a separate option to take a fixed number of points and/or a fixed fee (either of which could be fixed at zero in one option) at a future closing date, while setting the maximum and/or minimum interest rate lock trigger relatively low so if the lock is triggered, the locked rate plus the agreed points and fees assessed are not more than the offeree is willing to pay.

Further, fees for other products that are associated with a mortgage could be adjusted to secure the loan, in lieu of lowering the interest rate fully to market, should the prevailing interest rates go down. For example, appraisal fees, application fees, and other fees and costs associated with obtaining a mortgage could be waived either fully or on a sliding scale, should interest rates go down by a specified amount. Paying an offeree to accept a higher-than-market interest rate in exchange for lower front-end costs would tend to keep a customer who wants to minimize closing costs from finding an alternative lender if interest rates go down while the loan is pending.

Another contemplated feature is a set of options at two or more levels in the transaction. For example, the mortgage broker may provide a minimum, maximum, or combined rate lock option to the customer. The mortgage broker may cover this option by buying an option from the correspondent lender. The mortgage broker may limit the second transaction to barely cover the option given to the customer, as by obtaining an option to lock in the same maximum interest rate locked in by the customer, using the same maximum trigger price accepted by the customer. Alternatively, the mortgage broker may buy a more expensive option to lock in a lower price than the maximum trigger price accepted by the customer. That way, if the price rises enough to trigger the customer's lock option, it first will have risen high enough to trigger the broker's somewhat lower maximum rate lock option, thus providing profit to the mortgage broker.

If the price (such as the loan interest rate) rises high enough to trigger the broker's rate lock but never triggers the customer's rate lock, the further movement of interest rates can have three possible outcomes.

First, if the customer closes the loan at a price between the two trigger points, the broker will profit by getting the money at a lower rate than is offered to the customer.

Second, if the customer manages to close the loan at a price lower than the broker's trigger price, the broker can abandon the rate lock option (because in at least one contemplated embodiment the option is not required to be exercised) and get funds at the lower prevailing rate (typically less a discount, as under given conditions the broker is given a lower interest rate), possibly though not necessarily from another correspondent lender.

Third, if the customer closes at exactly or very nearly the broker's trigger price, the broker will have lost whatever it paid for the option, as the option will provide no advantage over the market price. But in this instance the usual compensation for a mortgage broker (such as discounts on services procured by the broker) will provide a measure of profit. This source of profit is available regardless of the outcome as outlined above, though reduced by the price of the option.

The contemplated options can have conditions other than a strike price that are to be met before the offeree is entitled to exercise the option. For example, the option might be such that if the strike price is met, the offeree further agrees to satisfy all conditions needed to close the loan within 15 days to be entitled to exercise the option.

### INDUSTRIAL APPLICABILITY

Industrial applicability is representatively directed to computer control and implementation therefrom, as well as in computer networking, communications, transmission systems, receiver systems, and data processing and more, any and all of which are applicable to the computer science and electrical engineering industries, as well as industries operating in cooperation therewith. Depending on the implementation, there is apparatus, a method for use and method for making the apparatus, and corresponding products produced thereby (e.g., documentation, templates, interfaces, and other output), manufactures, as well as data structures, computer-readable media tangibly embodying program instructions, manufactures, and necessary intermediates (e.g., data, schema, computations, etc.) of the foregoing, which in turn correspond to digital aspects of embodiments indicated herein.

Technical Implementation

The following products, machines, and processes implemented in machines are non-limiting examples of technical implementation.

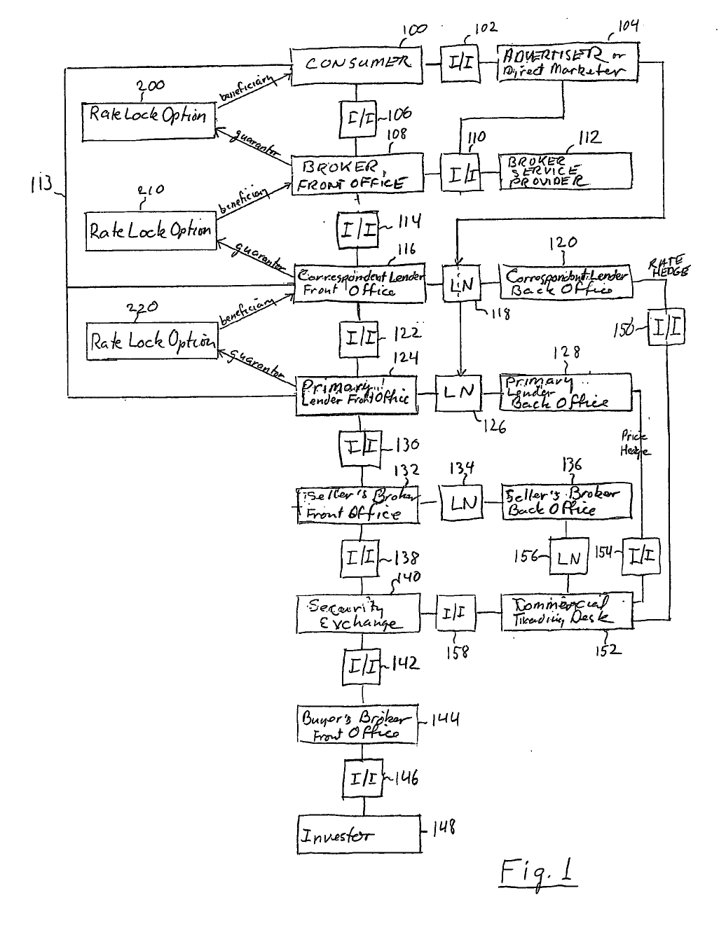

Turning to the drawing figures, the computer network shown in FIG. 1 is one embodiment of the computers or analogous communication and computation hardware that can potentially be involved in a typical mortgage loan transaction. Reference here to a computer is not limited to the conventional meaning of the term, and includes without limitation any of these alternatives or other hardware/software carrying out analogous functions or leading to an analogous result. Each illustrated computer can be a desktop computer, a mobile (e.g. laptop tablet, or palmtop) computer, an e-mail terminal, real-time terminal, a land line telephone, a cell phone, a dedicated microprocessor, etc.

As used herein, the term “computer” generally refers to hardware or hardware in combination with one or more program(s), such as can be implemented in software. Computer aspects can be implemented on one or more general purpose computers or specialized devices, and can operate electrically, optically, or in any other fashion. A computer as used herein can be viewed as at least one computer having all functionality or as multiple computers with functionality separated to collectively cooperate to bring about the functionality. Logic flow can represent signal processing, such as digital data processing, communication, or otherwise as evident from the context hereinafter. Logic flow can be implemented in discrete circuits. Computer-readable media, as used herein can comprise at least one of a RAM, a ROM, a disk, an ASIC, and a PROM.

The functions shown as being carried out by a single computer can be carried out by more than one computer, and the functions shown as being carried out by more than one computer can be carried out by a single computer, without departing from the present intent.

A “network” as described here can be a preconfigured network, like a local area network (“LN”) of computers, servers, and peripheral devices in a single office, or an ad hoc network caused by the temporary interconnection of computers over the Internet, by modem, via telephone, cable television, radio communication, combinations of these (like a telephone call made in response to a television solicitation), or otherwise to conduct a particular transaction. In the latter sense, the computers in the network do not need to all be linked up at once; as few as two of them can be linked at a time. The link can be a formal link or a casual link, as by sending e-mails or other communications from one computer to the other, or logging one computer into a web site maintained on another via the Internet.

As is conventional, the Internet connections or communication paths described above can be made in various ways. In one embodiment, the Internet connection can be enabled by a series of devices and transmission lines or paths including:
a first computer,
a modem connected to the first computer,
a telephone (regular or DSL) or cable television transmission line or radio communication channel connected with or generated by a transmitter associated with the modem,
a first Internet Service Provider (ISP) receiving the communication,
the Internet, to which the first ISP is connected,
a second ISP connected to the Internet, receiving the communication,
a telephone or cable television transmission line or radio communication channel connected with or generated by the ISP,
a modem connected to the second computer, and the second computer.

It will be understood that not all of the individual entities shown in FIG. 1 will necessarily communicate or deliver items by computer. Other means of communication and delivery, such as telephone communication, facsimile communication, hard copy delivery, or delivery of a DVD or CD containing data or programming for loading on a computer, are also contemplated in place of or in addition to one or more of the illustrated computer communication and delivery links shown in FIG. 1.

Thus, for example, the option can be given from an originator (offeror) to a borrower (offeree), or otherwise, conveyed as appropriate for the channel of commerce, e.g., electronically, by paper preferably generated according to an embodiment herein, a contract, etc. The borrower may, but need not in all embodiments, know of the option. Where appropriate, there can be a disclosure of the option. If the borrower has chosen to have the lock option, then there can be a disclosure that the borrower prefers an interest rate to be secured on its behalf without giving subsequent consent or other communication. There is a paper that one or both parties sign, and the mechanics of gathering the information includes entering the information into a computer by someone suitable in the relevant business channel.

Referring now in detail to FIG. 1, in this embodiment, the customer's computer 100 is operated by or on behalf of a person or entity seeking a loan. The computer 100 is linked by the link 102, which can be an Internet link Internet service provider (“I/I”) or other means of communication, to the computer 104 of an advertiser or direct marketer. The link can be established by the advertiser sending a solicitation to the customer, by the customer locating and communicating with the advertiser or direct marketer, or in other ways. Advertising can include telemarketing, Internet, referral (e.g., client, business (e.g., realtor, CPA)), and other advertising all in machine-aided cooperation of a system in which the option is a part. Advertising can similarly extend to providing education materials illustrating how the option works. It should be noted that the customer, and thus the customer's computer, might deal directly with the broker or correspondent lender (as described below) without contact between the customer computer 100 and the advertiser or direct marketer's computer 104.

The computer system of FIG. 1 can be programmed for eliciting information regarding a potential customer who contemplates carrying out a financial transaction; eliciting a future lock-triggering price contemplated by the customer for the financial transaction; determining whether the lock-triggering price is available; and if and when the lock-triggering price becomes available, communicating that the lock has been triggered.

The customer computer 100 can also or subsequently be linked, as by the link 106, to the “front office” computer 108 of the broker, which is a computer used by the broker for communication of information and documents between it and one or more of its suppliers and customers. The computer 108 is connected via links 110 to the computer 104, to provide current information, approve ad copy, or otherwise communicate with the computer 104.

The computer 108 for the broker's front office is also connected via the link 110 to the computer 112 of the broker service provider. Because many brokers are very small firms with few regular employees, it is contemplated that brokers may engage a separate entity as a broker service provider to do the computation, secondary market watching, rate lock computations, etc., needed to conduct its business. A larger broker entity may accomplish some or all of the same tasks in-house, for example in a back office computer system.

The customer might in some cases deal directly with the correspondent lender directly, without using a broker, in which case the communications and interconnections involving the broker can optionally be made directly between the customer computer 100 and the correspondent lender's front office computer 116 via the path(s) 113.

The computer system of FIG. 1 can also be programmed for evaluating the information and lock-triggering price to determine whether the financial transaction is acceptable to a seller that contemplates participating in the financial transaction. This may be done, for example, in the back office computer 112 of the broker service provider.

Thus, the system of FIG. 1 can be programmed for eliciting information regarding a potential customer who contemplates carrying out a financial transaction; eliciting a future lock-triggering price contemplated by the potential customer for the financial transaction; and communicating the future lock-triggering price to a potential supplier of the financial transaction, such as the broker.

The broker's front office computer 108 is in this instance linked via the link 114 to the front office computer 116 of a correspondent lender. A “correspondent lender” as used here is the bank or other financial institution that deals either with the broker or the customer and commonly directly supplies the money for the transaction when the loan closes. The correspondent lender can be an independent retail bank, a branch of a bank group or network, or another suitable person or institution.

In an alternate arrangement in which the correspondent lender is a branch bank, the front office computer 116 at the branch bank can linked to the front office computer system, the back office computer system, or both computer systems of the headquarters bank.

The computer 116 of the correspondent lender is (in this embodiment) connected via the link 118, which can be an Internet linkage, and intranet linkage, a local area network connection via a server, or other forms of connection, to a computer 120 in the correspondent lender's back office. The back office computer 120 is commonly used do the computation, secondary market watching, rate lock computations, portfolio analysis and reporting, hedging placements, etc., the lender needs to conduct its business.

The correspondent lender's front office computer 116 can also be connected via the link 122 with a front office computer 124 of a primary lender. A primary lender is another, usually larger, lender that may buy mortgages from the correspondent lender, lend money to the correspondent lender to finance mortgages, sell rate lock options to the correspondent lender, or perform other functions.

The primary lender's front office computer 124 may be linked by a link 126 to a back office computer 128, which again might be used to do the computation, secondary market watching, rate lock computations, portfolio analysis and reporting, hedging placements, etc., the primary lender needs to conduct its business.

The advertiser or direct marketer's computer 104 can also be connected via the links 118 and 126 to the correspondent lender and/or primary lender, or both, instead of or in addition to being linked to the broker 108 via the link 110.

Some banks operate without a primary lender for some or all of their transactions. In other instances, a series of two or more primary lenders may participate, and each primary lender and a preceding primary lender may have a relationship comparable to that shown here between the correspondent lender and the first primary lender. A very large loan, such as a commercial loan, may involve a syndicate of more than one primary lender.

The front office computer 124 of the primary lender may be connected by a link 130 to the front office computer 132 of an investment broker acting as a seller's broker respecting this transaction. The seller's broker typically will also have a link 134 from its front office computer 132 to a back office computer 136 which is used to do the computation, secondary market watching, rate lock computations, portfolio analysis and reporting, hedging placements, trading, trade clearance, internal trading, etc., the seller's broker 132 needs to conduct its business.

As another aspect, with consideration to a bank (e.g., without a mortgage broker), banks tend to have less option flexibility than elsewhere in the chain of commerce relating to mortgages, such that in today's manner of business an option on an interest rate would be less commonly applicable. Nonetheless, it is possible for a bank to utilize an option approach, for example, an option on closing costs, commissions, or some other transaction cost. As discussed elsewhere herein, one kind of option embodiment suitable for a bank (or lender) is an option on a line of credit, such as a home equity line. Similarly, a bank can offer a cash out option, triggered when a certain prospect exists to take cash out from a property corresponding to a loan.

As to a bank or lender, for example, ways to lock can include on line, e.g., at a bank web site, which is adapted to handle loan applications and communicate spread sheets. Spread sheets can be generated in a format structured to accommodate the lock option system by having an indication that certain loans or aspects of the loans, such as rates, are optionable. Similarly, loan application forms can be generated in a format to accommodate the lock option system. In the sheets and forms, if there is a charge for the lock option, there can be a corresponding payment indication.

Now consider further a lender, which can be similar to a bank, but can be another form of lender, e.g., some other party offering a line of credit. Thus, while such lending as a home equity line of credit can be related to the prime interest rate, an option can utilized herein as well. A lender can have a window for an option with an investor too. At some level between the correspondent lender and the seller's broker, inclusive, a group of individual loans, particularly closed residential mortgage loans, are bundled together or securitized to form a mortgage-backed security. In an alternative arrangement, instead of securitization by a private entity, the loans can be bundled by a government institution such as the Federal National Mortgage Association (Fannie Mae) and sold by the government institution to investors. In this alternative, a primary lender commonly sells the loans to the government institution, which takes the place of the brokers and exchange, as it directly sells securities to investors.

Loans to be securitized currently are bundled together and sold after the loans have closed, as a portfolio having a fixed value, composed of loans made to specific borrowers for specific amounts. Loans intended to be securitized can alternatively be bundled together and tracked while the loans are still pending, for handling together and ensuring that they have uniform provisions suitable for a securitized loan.

A data structure for a portfolio of loans tracked to be securitized can include a database of records, each record constituting data documenting a pending loan application, the data structure defining a pool of pending loan applications, each configured for backing a loan-backed security, wherein at least one application in the pool identifies a future lock-triggering price at which the loan will be locked if the triggering price becomes available.

Returning to FIG. 1, the seller's broker may also have a link 138 to a computer 140 defining a security exchange (which may also be a live exchange, in an alternative embodiment). The computer 140 matches buyers and sellers to conclude a transaction. The mortgage-backed security is sold via the link 138, the exchange computer 140, and the link 142 to the computer of a buyer's broker 144. The computer of the buyer's broker is connected by the link 146 to the computer 148 of an investor on whose behalf the buyer's broker has purchased the mortgage-backed security. In this final transaction the broker reports the transaction on the exchange computer 140.

The seller's broker, the buyer's broker, or an independent broker may also participate in hedging transactions related to the origination and sale of a mortgage or other loan according to an embodiment herein. In the exemplary arrangement shown in FIG. 1, the seller's broker is also participating in hedging transactions. For example, in this embodiment the back office computer 120 of the correspondent lender is connected by a link 150 to the commercial trading desk 152 of the seller's broker. Similarly, in this embodiment the back office computer 128 of a primary lender is connected by a link 150 to the computer at the commercial trading desk 152 of the seller's broker. The lenders can use hedging transactions, such as the purchase or sale of interest rate options, to buy protection from the risk involved in rate lock options they have given.

The commercial trading desk computer 152 is linked to the broker's back office computer 136 for watching the secondary market pertinent to a rate lock or other option, pricing options, carrying out internal trading, and performing other tasks to support the sale of hedging transactions.

Like the computer 132 of the seller's broker, the computer 152 of the commercial trading desk is connected by a link 158 to the security exchange 140 (or a different security exchange, in another embodiment) in which interest rate options and other securities useful for hedging against interest rate fluctuations are sold.

Continuing with FIG. 1, a rate lock option 200 can be provided by a mortgage broker to a customer via their respective computers 108 and 100. A rate lock option 210 can be provided by a loan originator to a mortgage broker via their respective computers 116 and 108. A rate lock option 220 can be provided by a primary lender to a loan originator via their respective computers 124 and 116. Other rate lock options can also be provided without departing from the scope intended herein. An offeror indirectly linked to the offeree can provide an option. For example the correspondent lender might make an option directly available to a customer as part of its product offering, even though a mortgage broker has arranged the transaction between them.

As to a loan underwriter, the loan application can be processed based on a worst case scenario defined by the option or in a manner analogous to prequalification for a mortgage, or as in the case of a float. Though FIG. 1 does not show the underwriter computer, such should be understood to interact therewith. For further information, see, for example the discussion of an embodiment into the Genesis or other mortgage processing software system below.

A template can be generated in the customer's computer 100 for associating data indicating a desired price lock with data indicating a customer identity. The template can include one or more data fields displayed on the customer computer 100 to receive information from a customer and one or more prompts displayed on the customer computer 100 encouraging data entry or showing what to enter or where to enter it on the template. A template can be useful in creating a data standard where many parties can be involved. For illustration purposes, data fields can be an APR combined with a date or term corresponding to the option; loan interest rate with a termination date or term is another possibility. Depending on the embodiment, other particulars such as a charge for the lock option can also be designated in a template, along with a float down add on, etc. A template can also be used for an embodiment enabling modification of a lock option. It is imagined that likely most lock options will be handled on line, e.g., by importing a file where needed for further processing (see discussion of transmission and receiver systems below).

More specifically, the template can include first and second data fields and a prompt relating to at least one of them. A first data field of the template is configured to receive an entry of data indicating a desired future lock-triggering price for a contemplated transaction. The template can have a prompt soliciting a potential customer to enter data indicating a future lock-triggering price in the first field. The template can further include a second field configured to receive an entry of data indicating the identity of a potential customer contemplating the transaction. Option expiration can, if desired, be set to an event corresponding to receipt of closing papers.

The template can be implemented, for example, in a programmable digital computer. The computer can have a screen configuration, an audio file, or other media communicating one or more prompts. The screen can display a physical representation of one or more data entry areas corresponding to each data field stored in a memory of the computer. The computer can have a data entry device and a cursor or pointing device navigable on the screen to the data entry areas. The computer can be programmed to store in a suitable data field the data entered in each data entry area. Alternatively, the template can be implemented in one computer, such as a lender's computer, interacting with a customer computer. The lender's computer can generate the screen display described above on the customer's computer, and can include a memory containing the data fields described above. The customer's computer can be used to navigate to the data entry areas presented on its screen and to provide data for transmission to the remote data fields in the lender's computer. In some automated implementations, the option possibilities can be provided by one or more icons clickable for carrying out a selection or by limited selectable alternatives for a data field.

Another implementation of the template is in a telephone-operated configuration. The lender's telephone system can generate audio signals communicating the prompts indicated above to the customer's telephone receiver, eliciting the customer to enter data for the data fields described above by speaking the words into the telephone or pressing buttons on the telephone keypad. The data thus entered is transmitted through the telephone connection to a digital computer associated with the lender's telephone system, where the data fields are maintained.

One or more of the computers of the system shown in FIG. 1 also can function as a machine for establishing a price lock for a future transaction subject to market price fluctuations. The machine can comprise means for establishing a future lock-triggering price for the transaction; means for determining in the future whether the market price for the transaction has reached the future lock-triggering price, and means responsive to the determining means for communicating that the market price for the transaction has reached the future lock-triggering price.

One example of suitable means for establishing a future lock-triggering price for the transaction is a data structure for entering a future lock-triggering price.

An example of suitable means for determining in the future whether the market price for the transaction has reached the future lock-triggering price is a market price monitor programmed for determining in the future whether the market price for the transaction has reached the future lock-triggering price. The monitor can be programmed in, for example, the primary lender's front office computer 124 to periodically query a web site or other source of market price information, for example the computer 132 of the seller's broker's front office 132 relaying information from the security exchange 140, to find the current market price. The monitor can be programmed to query the data structure recording the transaction, which may be located (as one example) in the primary lender's back office computer 128, to find unlocked transactions that are to be locked in view of the current market rate determined by the monitor, and update their status accordingly.

An example of suitable means responsive to the determining means for communicating that the market price for the transaction has reached the future lock-triggering price is an output for communicating data indicating that the market price for the transaction has reached the future lock-triggering price.

Thus, the machine for establishing a price lock for a future transaction subject to market price fluctuations can comprise a data field for entering a future lock-triggering price for the transaction, a market price monitor programmed for determining in the future whether the market price for the transaction has reached the future lock-triggering price, and an output for communicating data indicating that the market price for the transaction has reached the future lock-triggering price.

In an embodiment of FIG. 1, any one or more of the computers 100, 104, 108, 112, 116, 120, 124, 128, 132, 136, 140, 144, 148, and 152, and any other computer employed in the illustrated arrangement, can be a complete computer system in itself. Each of the computers provided in the form of a computer system can include an operatively connected processor, memory, input device (for example, a keyboard, keypad, stylus, mouse, track ball, or other pointing device, or a speech-to-text converter), output device (for example a display, printer, or text-to-speech converter) a communication device (for example a modem), and a system control to carry out its respective activities. The system control can be embodied, for example, in the form of a computer program.

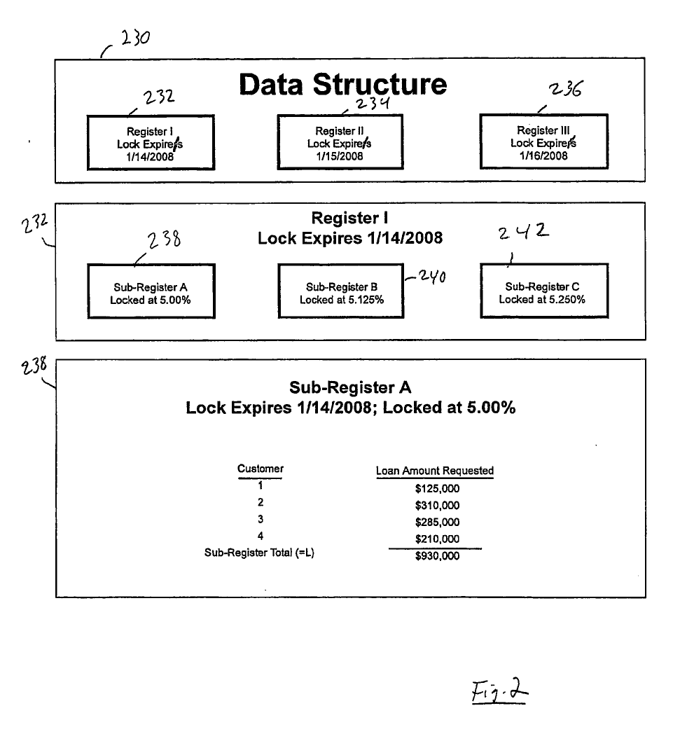

FIG. 2 is a schematic view showing one embodiment of a data structure 230. The data structure 230 is useful for storing rate lock portfolio information in a form that minimizes the number of calculations needed to manage a heterogeneous portfolio. The technical implementation of the data structure 230 can be an optical, magnetic, or semiconductor storage medium or memory configured to define a database.

The data structure 230 is organized in a three-level hierarchy or directory tree in this embodiment. The data structure 230 includes one or more—commonly many—registers, here 232 (Register I), 234 (Register II), and 236 (Register III), at the first level. Each register in this embodiment represents the portion of the portfolio having a rate lock option that expires—may no longer be exercised—as of the same date. An initial sort by expiration date allows easy identification and separation of expired, unexpired, and exercised options in the portfolio for separate handling.

The registers of the structure 230, such as 232, are further divided up at the second level according to the lock rate. The Sub-register A, at 238, of Register I records pending loans having an interest rate lock at 5.00%, for example. Keeping records of multiple loans having the same interest rate lock together allows them to be processed to record locks as a group, avoiding some individual processing. Sub-registers 240 and 242 are also shown.

The sub-registers of the structure 230, such as 238, can contain one or many records of individual rate lock agreements, defining the third level of the hierarchy. For reasons which will become clearer, it is useful to aggregate the loan amounts subject to the same rate lock together, to show how much loan volume is involved, and thus how much risk is involved, at each lock rate and expiration date.

Registers and sub-registers can also be provided in the data structure for loans that are not subject to a rate lock agreement, to manage them as well.

As an alternative to the hierarchical data structure of FIG. 2, the data can also be arranged in the fields of a searchable database, and the operating program can be used to identify the related pending transactions corresponding to the sub-registers for processing them together.

The technical implementation of FIG. 2 can be, for example, a data structure formed by a computer-readable magnetic, semiconductor, or optical recording medium (as three non-limiting examples) on which data is recorded. The data recorded in the data structure to reflect a particular transaction can comprise, for example, a future lock-triggering price for a contemplated transaction and data indicating a potential customer associated with the contemplated transaction. Another example of suitable data in the data structure to reflect a particular transaction is a desired future lock-triggering price for one or more contemplated transactions and the monetary value of the one or more contemplated transactions.

Another technical implementation is a data structure, implemented as described above, comprising a database of records, each record constituting data documenting a pending loan application, the data structure defining a pool of pending loan applications, each configured for backing a loan-backed security, wherein at least one application in the pool identifies a future lock-triggering price at which the loan will be locked if the triggering price becomes available.

Still another technical implementation of the data structure can be a database recorded on a computer readable medium, the database comprising a multiplicity of records of different transactions. At least some of the records can include a desired future lock-triggering price for a contemplated transaction and a monetary value representing the scale of the contemplated transaction.

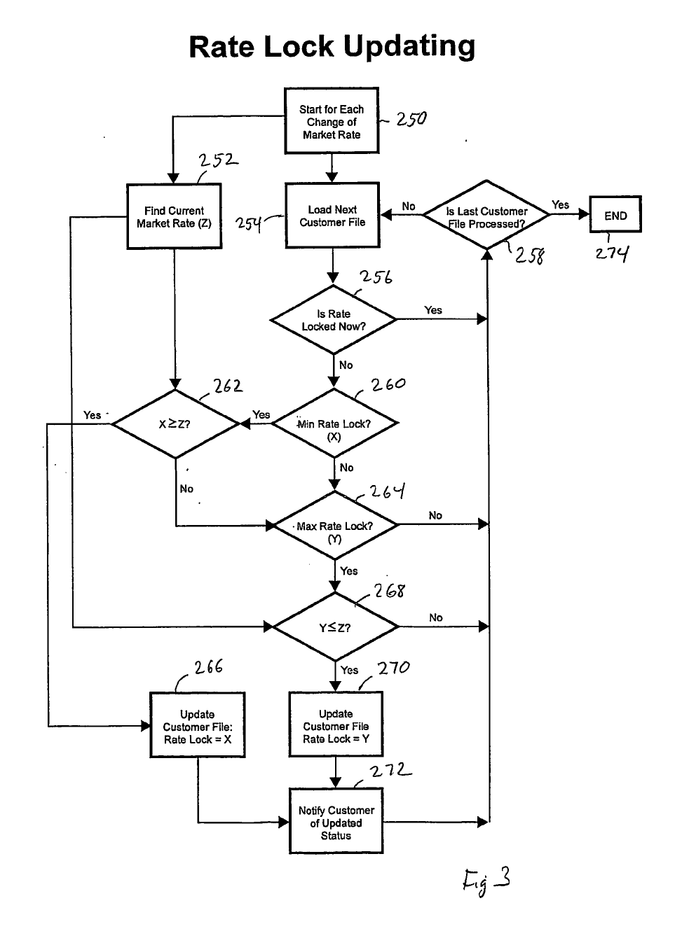

FIGS. 3-5 show exemplary tools that can be used by the offeror of a rate lock option to manage a portfolio of rate lock business represented by the data structure of FIG. 2, particularly where the offeror is managing many different rate locks in one portfolio.

FIG. 3 shows one embodiment of a method for updating rate lock files to reflect which rate locks have gone into effect. When the market rate for the interest rate or other financial term that is the subject matter of the rate lock option changes, and preferably but not necessarily each time it changes, a portfolio of rate lock options can be updated to reflect which ones have locked because the previous update. The portfolio commonly will be updated frequently so timely decisions can be made about handling the portfolio.

In the portfolio database, an indicator such as a flag or otherwise (e.g., absence of a flag to signify a float) can be used to identify the lock option status (e.g., option, and where appropriate, type of option, etc.), distinguishing that status as a different status from a float status or a locked status. That is, a lender can have different alternatives, including floating, lock, and/or option(s).

Referring to FIG. 3, the method can start at step 250, optionally each time the market rate changes. Updating begins by ascertaining the current market rate (Z), as shown in the step 252. Next, a first file to be updated (such as Sub-register A) is accessed, for example by loading Sub-register A; this is shown as the step 254.

Next, Sub-register A is addressed in the decision step 256 to ascertain whether the rate lock has already been triggered, so the rate in question is already locked. If yes, the lock does not need to be updated for Sub-register A (unless additional locks are possible after a first lock is effective, which is alternatively contemplated), so the method proceeds to the question 258 asking whether Sub-register A is the last customer file to be processed. Assuming it is not, the next customer file (for example, Sub-register B) is accessed at the step 254 and the process continues.

If the answer at the step 256 is no for Sub-register A, the next question, raised at the decision step 260, is whether Sub-register A has an untriggered minimum rate lock: a term in an agreement that the rate will be fixed at a certain value if the market rate Z drops to the locked value (here defined as X) or less. If the decision at step 260 is yes, the next step, 262, is to determine whether the minimum rate lock has been triggered. This is done at the decision step 262 by determining whether the market rate Z has dropped to or below the agreed minimum lock rate X. In other words, is X greater than equal to Z? If the answer at the decision step 262 is yes, the rate is locked at X, and Sub-register A is updated at the step 266 to reflect this.

If the answer at the decision step 262 is no for Sub-register A, in this embodiment Sub-register A is further examined at step 264 to see whether the corresponding agreement has another untriggered rate lock, here a maximum rate lock (at rate Y) requiring consideration. If the answer at step 264 is no, processing of that file is complete and the method turns to the next file—Sub-register B—if any. If the answer at step 264 is yes for Sub-register A, processing of that file continues at the decision step 268.

At decision step 268, the operative question is whether the so-far-untriggered maximum rate lock at rate Y is triggered by the new market rate Z reaching or exceeding Y. In other words, is Y now less than or equal to Z? If yes, the file is updated to show that the rate is locked at Y, as shown at step 270. If no, the processing of that file is complete and the method turns to the next file—Sub-register B-if any.

Finally for Sub-register A, if a rate lock at X or Y has been established in this iteration, the customer, lender, or other interested party can be notified, as in step 272 of this embodiment, and the process continues at decision point 258. If the last file has been processed for the current market rate Z, the process ends at step 274, to resume the next time the files are to be updated. As described previously, if Sub-register A is not the last one to be processed, the next file, Sub-register B, is loaded or otherwise accessed to continue the method until all the customer files have been processed.

The technical implementation of FIG. 3 can be a computer system having a memory storing records of the database of loans and a computer processor programmed for reading the associated lock-triggering prices in the database, searching an outside source or a separate record in the database for prices offered by sellers of the transactions corresponding to the lock-triggering prices. When a price offered by a seller of the transactions corresponding to one or more of the lock-triggering prices is located, the computer processor can update the records in the database to indicate that the rate is locked.

Another technical implementation of FIG. 3 is a method for implementing a future rate lock for a financial transaction that has a market rate. The method includes several steps. One step is providing the following apparatus: a digital computer comprising a processor for receiving input data, processing the input data to produce output data, and outputting the output data; a memory operatively connected to the processor for storing and retrieving machine-readable data input to and output from the processor, and a program operatively connected to the processor to form circuitry in the processor for controlling the processor to receive the input data and to produce and store in the memory the output data. Another step is inputting data to the processor identifying the customer and a proposed future triggering rate which the customer proposes to lock in if the market rate reaches the proposed triggering rate. An additional step is inputting data to the processor identifying the current market rate at which the financial transaction is being undertaken. A further step is using the processor to compare the proposed future triggering rate to the current market rate; and if the current market rate reaches the future triggering rate, generating as output data in the memory a record indicating that the proposed future triggering rate has been locked.

The embodiment of FIG. 3 as described here can alternatively be carried out in many other ways without departing from the intent herein.

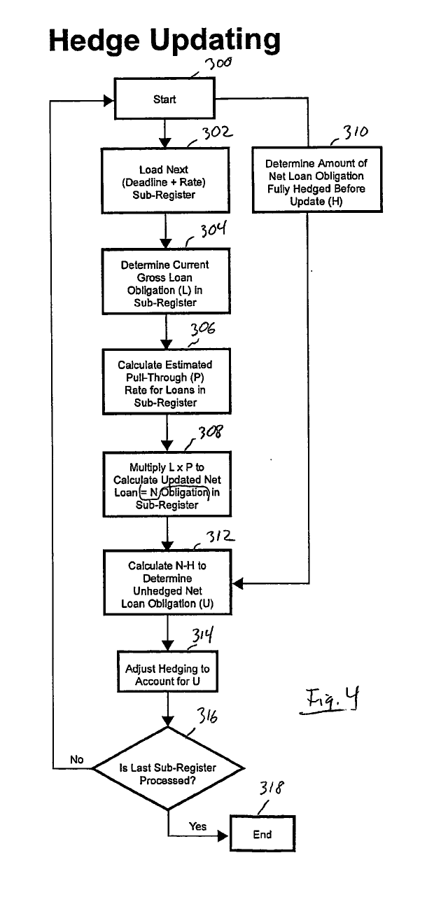

FIG. 4 shows one embodiment of a method for updating hedge rates. The need to hedge the pending loans in a portfolio will change according to the proportion of loans expected to actually close, which is called the “pull through rate,” shown as “P” in FIG. 4. If more loans than usual are expected to close, as when maximum rate lock options have been triggered and the market rate exceeds the option rate (so customers are entitled to a better-than-market interest rate if they close), the pull through rate P will increase. The pull through rate will decrease if the market rate drops relative to the option rate, so customers closing at the locked rate would not benefit (at all, or as much) from the rate lock. As is well known, many other factors also affect the pull through rate.

For a floor and/or ceiling interest rate option that the offeree chose, a hedge system can be used to determine the probability of option execution, e.g., interest rates going one way or the other, and then having those locks being placed. One approach is to use a probability model to determine the probability of certain circumstances occurring.

A shock analysis can be used to aid selection of a hedge. In shock analysis, typically there is an expectation of rates of moving up and/or down, by certain standard deviations. From these different deviations, a determination is made of expected “pull through,” i.e., what is the expected number of locks that will turn into loans. And in one possible analytic scenario, rate shock analysis can be applied to expected locks (instead of, or rather in addition to, expected closings). For perspective, interest rate shock analysis has utility in predicting how many loans will close, and the analysis can be used as one means for determining how many of those options will result in a lock. Subsequent analysis can be used to estimate closings.

Turning to FIG. 4, one embodiment of a tool for updating hedging of a portfolio of loans to account for changes in the pull through rate is provided. Hedging commonly will be updated daily to stay abreast of changing market conditions, though shorter, longer, or irregular intervals are also contemplated. Starting at step 300, a sub-register such as 238 (FIG. 2) representing a particular lock rate and lock option expiration date is loaded or otherwise accessed at step 302. The current gross loan obligation L in the sub-register is determined at step 304—this is the volume or amount of principal the lender will be obligated to lend if all the loans in the sub-register close. An updated pull through rate P is then calculated or estimated at step 306, using historical experience, mathematical modeling, a formula, review of the tendencies of individual borrowers, underwriting results, or other sources of information. The loan obligation L is multiplied by the pull through rate P at step 308 to determine the expected volume or dollar value N of loans in the sub-register that are expected to close.

Separately, in step 310, the volume of loans in the sub-register that is already fully hedged (H) so far is determined. H is then compared to N at step 312 to determine whether the amount of hedging is correct, based on the currently expected volume of loans that will close. The amount of hedging is then adjusted in step 314, optionally using well-known vehicles such as pre-selling the loans, interest rate futures, or others, to be suitable in view of the expected pull through rate. The expected pull through rate can be just covered by hedging or over-covered, if a safety factor is desired and economically justifiable.

If multiple sub-registers are to be processed, the next step is to determine whether additional sub-registers need to be processed, indicated as decision step 316 in FIG. 4. If so, the routine can end, as shown at 318. If not, the routine can continue for another sub-register representing active applications having a different option expiration date, option terms, or other differences.

Commonly, it will be useful to separately process loan applications of different types, as the differences between them commonly will affect their respective pull through rates. If, however, two or more different subregisters are found to have similar pull through rates under the prevailing market conditions, or if a composite of two or more sub-registers have a predictable average pull through rate, the blended or averaged sub-registers can be processed together through the routine shown in FIG. 4.

In another variation of FIG. 4, the return loop can extend from step 312, representing calculation of the unhedged net loan obligation for one sub-register, to step 302, loading or otherwise accessing another sub-register. Then, in this alternative embodiment, the hedging adjustments of the step 314 can be carried out once the values of U for all active sub-registers are determined.

A technical implementation of FIG. 4 is a method for calculating risk exposure resulting from accepting a portfolio of future rate locks for financial transactions triggered by the market reaching a predetermined trigger rate, comprising several steps. One step is providing suitable digital computer apparatus for carrying out the method, including a processor for receiving input data, processing the input data to produce output data, and outputting the output data; a memory operatively connected to the processor for storing and retrieving machine-readable data input to and output from the processor; and a program operatively connected to the processor to form circuitry in the processor for controlling the processor to receive the input data and to produce and store in the memory the output data. Another step is inputting to the processor the gross volume of loans in a portfolio locked in at a particular lock rate. Additional steps include inputting to the processor a pull through rate for the portfolio; computing with the processor the product of the gross volume of loans and the pull through rate, thus determining the estimated net volume of loans that will be closed at the particular lock rate; and outputting to the memory the estimated net volume of loans that will be closed at the particular lock rate.

Another technical implementation of FIG. 4 is a method for hedging the risk exposure resulting from accepting a portfolio of future rate locks for financial transactions triggered by the market reaching a predetermined trigger rate. One step of the method is providing a digital computer apparatus comprising a processor for receiving input data, processing the input data to produce output data, and outputting the output data; a memory operatively connected to the processor for storing and retrieving machine-readable data input to and output from the processor; and a program operatively connected to the processor to form circuitry in the processor for controlling the processor to receive the input data and to produce and store in the memory the output data. Another step is carried out by inputting to the processor the estimated net volume of loans in a portfolio that will be closed at a particular lock rate and the volume of loans that are fully hedged. Two other steps of the technical implementation are computing with the processor the difference between the net volume of loans that will be closed and the volume of loans that are fully hedged, producing as output data the amount of hedging transactions to properly hedge the portfolio; and storing the output data in the memory of the computer.

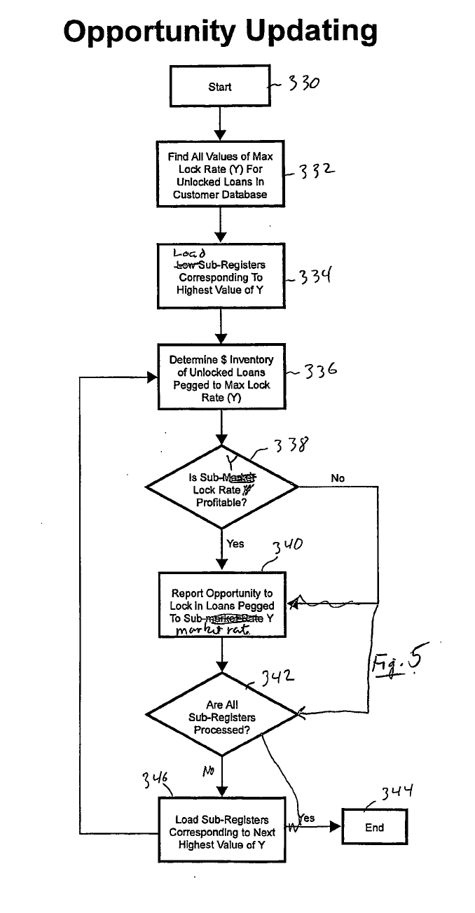

FIG. 5 shows one embodiment of a method for opportunity updating. This method addresses the situation in which a maximum lock rate has been provided to a prospective customer, so the customer is entitled to the lock rate even if the prevailing market rate goes higher, but the market rate has remained below the lock rate, or has dropped after the rate is locked, so the lock rate option is of diminished value to the loan applicant. An applicant in this situation may be subject to diversion by another loan provider who offers a lower lock rate or a closing rate lying between the market rate and the lock rate. Diversion affords the diverted customer a lower rate, and costs the original loan provider business.

To avoid this diversion and push more loans to completion, where there is no float down, the loan provider can contact customers who have relatively high maximum lock rates and offer either to lower the lock rates or to close the loan at a lower rate than the lock rate the provider is then obligated to provide. This is sometimes known in the trade as “shaking the money tree” to increase the pull through rate of loans having high maximum lock-in rates, compared to the contemporary market rate.

One contemplated process is shown as FIG. 5. Turning to FIG. 5, the process starts at step 330. The database of pending loans is queried at step 332 to find currently-unlocked loans having a maximum lock option rate Y. In an embodiment, the first sub-register processed, at step 334, can be the one representing pending loans having the highest value of Y. For a given market rate, the sub-register(s) showing the highest values of Y desirably can be processed first, as these are the loans in which the customer is getting the least benefit from the lock option and is most subject to a diversion by a third party offering a rate below the option rate. Optionally, however, the sub-registers can be processed in a different order.

At step 336, the inventory of unlocked loans pegged to a max lock rate Y is determined, to measure the extent of the business subject to loss if these loans do not close. If little business is pending with an unlocked maximum rate Y, it might not be the best use of the lender's time to pursue these opportunities at a lower price, and vice versa.

The next question to be answered, at decision point 338, is whether a sub-Y closing price or option offered to prospective customers will be profitable. If yes, then the opportunity to lock in loans pegged to a sub-Y market rate is reported at step 340, either to the lender or, optionally, directly to the prospective customer, optionally in the form of an offer of new terms more favorable to the prospective customer.

The next step in the routine of FIG. 5 is to determine whether all the sub-registers have been processed, at the decision point 342. If yes, the routine can be ended, shown as step 344. If no, another sub-register, for example one representing the next highest value of Y (compared to the previously-processed value), is loaded at the step 346 and processed as shown in steps 336 and following.

The routine shown in FIG. 5 can also be applied to update opportunities if the loan is locked, either at a minimum lock or a maximum lock rate, but the subsequent market rate is lower than the locked rate, so again the prospective borrower is subject to being diverted by a third party offering a lower rate.

Beyond the analysis of the particular transactions subject to price or other locks, there can also be analysis relating to optimization, including the comparative shock analysis in determining product and product blend optimization and pricing. Such analysis can include determining how much business to get from one particular status in view of another product. For example, if there is movement on the price of the mortgage for option locks, that movement could have some effect on applications having other statuses as well, such as on locks with a float down, pull through for locked applications, etc. Thus, the analysis can also be directed to predicting total profit from rate or other movement. Here tracking and feedback learning from experience can be utilized. Note that typically shock analysis can be used for comparing products in a lender's pipeline, as contrasted with a use for an embodiment herein to determine an influence on the lender's other products, i.e., what change in business the lender can get from itself. That is, while lenders typically do not allow people to relock a finally locked loan application with the same lender, and shock analysis can be done to calculate not only how many applicants are going to go do business with someone else, but also how many applicants will change lender products.

Computing consequences of the option approach can also extend to price determinations. Some embodiments herein can include a new component to product pricing to accommodate the option situation: for example, if an offeror decides to change pricing to get more loans from the lock option, the pricing equation is not as it was, as discussed previously.

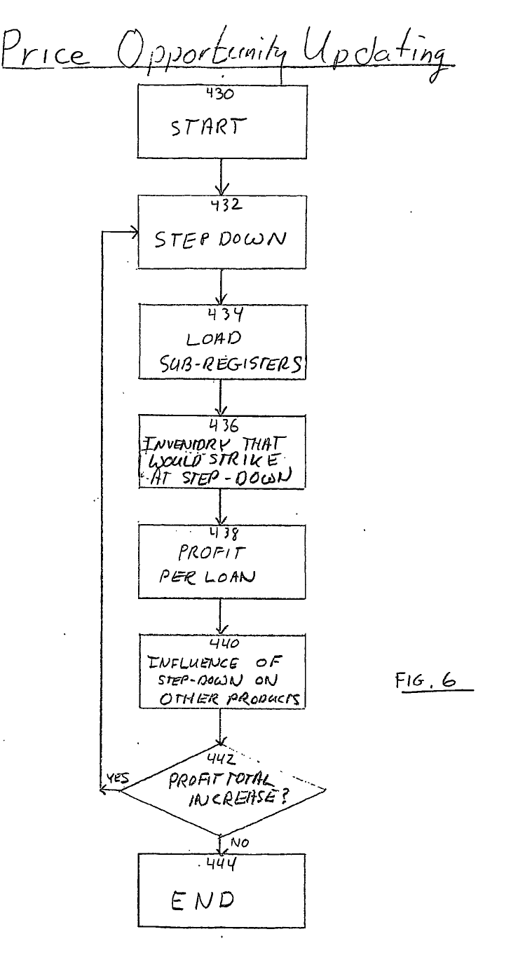

FIG. 6 shows another embodiment of a method for opportunity updating relating to pricing. This method addresses the situation in which no option, particularly a floor option, has been locked because the subject matter of the option, e.g., interest rate, is higher than the strike price for the option. In this example, an applicant may be subject to diversion by another loan provider who offers a lower lock rate. While parties in the lending process change rates and offerings in conventional ways to balance the quantity of business with the profit per mortgage so as to attain maximum total profit, a new kind pricing opportunity updating can be carried out with embodiments of the lock option system.

To avoid this diversion, the loan provider can change rates (or other option criteria) to optimally trigger the striking of the options, to close so many more mortgages, albeit at a lower profit per mortgage, that there will be a higher total profit for the lender. That is, while a typical lender knows its usual pull through rate and profit per mortgage, embodiments of the lock option system provide new information: the option positions of loan applicants. This new information can be used by the lender in pricing the product that is the subject of the option, and even altering pricing for the lender's other products so as to optimally account for the influence of a price change in one product on another product.

So, for example, the lender can use this new information (option positions) in determining whether it is likely to attain higher total profit by lowering its interest rate to lock in the options, producing more business, but at a lower profit per mortgage. This determining can include accounting for the lowering of interest rates, or other terms upon which option positions are based, upon the lender's other lending activity.

One contemplated process to carry out this embodiment of opportunity updating to address pricing is shown as FIG. 6. In FIG. 6, the process starts at step 430. At step 432, an existing mortgage price is stepped down, e.g., interest rate in this example, but any option term can be so handled.

The database of pending loans is queried at step 434 to find currently-unlocked loans having a minimum lock option rate X. In this embodiment, the first sub-register processed, at step 434, is the one representing pending loans having the value of X below the prevailing price.

At step 436, the inventory of unlocked loans pegged to a step in the minimum lock rate X that would strike at the stepped down price is determined, in measuring the extent of the business subject to capture if these loans close. At step 438, the profit per loan is determined. At this point in the process, the estimated pull through of incremental business and the profit per mortgage of that business is known. (Further learning as to pull through can come from analyzing the time held for different types of options and other option behaviors.)

At step 440, the process determines the influence of the stepped down price on other products of the lender. For example, if the lender drops the interest rate by ⅛ of a point, e.g., for a day or less, the lowered rate can influence the pull through on each of the other of the lender's products. At step 442, this influence on other products is taken into account in view of the added business from hitting the strike price for the options so as to determine whether there is a greater likely total profit from the step down in rates. If there is an increase in profit at decision point 442, the opportunity updating process loops back to step 432 for analyzing another step down, and if there is no increase, the process reaches an end 444 with a determination as to pricing.

In other embodiments, an option criteria other than price can be analyzed. Also, changes in other products can analyzed, e.g. by recursive analysis of loan product features in an ever changing market place. For example, while a step down in a rate for an option may adversely influence total profit, by changing another of the products, say a 30 year loan to a 15 year loan, the influence may not be adverse. Therefore, analyzing features of a plurality loan products as they influence each other, e.g., particularly in view of the new information provided by the option embodiments, is embraced herein. Information has value, and thus, in pricing the options, a party in the lending process, such as a lender, may decide to offer the option without charge. Alternatively, a cost for an option need not be great, or there could be a charge to the applicant for setting up the option if the lock occurs but the loan does not close. In another implementation, which has some similarity to an extended lock, an option can be defined upon ordering closing documents, and such an approach can involve a fee, and as may be desired, a credit at the closing.

By analogy, other offerors of options can analogously use the new information in its pricing and profit computing, and likewise where appropriate adjust pricing to cause execution of options.

If there is any charge, a computer-aided accounting of the charge corresponding to the applicant is embraced herein. However, depending on the embodiment desired, for example, it is possible that an applicant would be satisfied with a free option to spare the hassle of constantly monitoring fluctuating interest rates with an option position, and the lender would be satisfied with providing the free option to obtain the new information that is then used in product pricing.

Computing can, in a given situation, extend to business to business referrals, such as the above-mentioned incorporation of services such as free credit reports. An offeror having a lock option embodiment implemented can use the data as an end product too, with consideration given to borrower confidentiality, etc. Option-related data can also be used in communications corresponding with other lenders, in the context of indicating that if any one of them will hit a particular price, the communicator could pass the loan opportunity to the responding entity. This could result in another downstream transaction, e.g., turning around the opportunity by using the data to try to sell the opportunity to another entity. Or if a broker had a plurality of potential borrowers that would lock if anyone would offer loans at a trigger point, such as a 6% rate for a 30 year mortgage, then the broker can communicate this to others, such as wholesale lenders, that the first of any of them that provides the product at the option trigger point will effectuate a lock in of, say, 2 million dollars of business.

Additionally, a tracking system can optionally be provided that accumulates as much data as practical, following movement of the data to learn from it, for example, trends in sources of loans or characteristics in loans. Tracking extends to shock analysis tracking, and while batch processing can be done, real time processing is useful for rapidly knowing the changing exposure to the potential of people locking the loans.

Another technical implementation is a computer-aided method for producing an asset-backed security backed by a multiplicity of loans, the loans being defined by agreements between a multiplicity of borrowers and at least one loan provider. The method includes several steps, and some approaches can be seen in U.S. Pat. Nos. 6,070,151 and 5,563,783, incorporated by reference. In another manner, one step is storing in a computer memory (either all at once or progressively) a data structure recording a multiplicity of loans (a “multiplicity” is defined in this specification as a minimum of three items) undertaken by a multiplicity of borrowers and at least one loan provider. The data structure can include, for at least one loan, data corresponding to an automatic lock-triggering price agreed to govern the price of the loan if a defined market price reaches the lock-triggering price under the terms of the loan. Another step is updating the data structure to identify closed loans. This step can include identifying a set of multiple closed loans recorded in the data structure that are qualified to back a loan-backed security. Then, a loan-backed security is formed by preparing documentation operatively associating the set of multiple loans with the security as the backing for the security.

In another embodiment, regarding asset-backed securities, a system and method can be viewed as extending from the time of a loan application (or even earlier) through creation and expiration of a mortgage-backed security: one system, one process. Consider that there can be a data structure (herein referenced as a MBS data structure) structured to enable holding data corresponding to the mortgage-backed security. This MBS data structure is used by a computer system having a program of instructions executable to perform steps in accordance with carrying out the mortgage-backed security or action corresponding thereto.

The MBS data structure corresponds to another data structure (herein referenced as a MBS creation data structure) structured to enable holding data corresponding to data used in making the MBS data structure, by means of a respective computer system having a program of instructions executable to perform steps in accordance with creating the mortgage-backed security.

The MBS creation data structure corresponds to a data structure (herein referenced as a loan bundle data structure) structured to enable holding data corresponding to a bundle of loans, by means of a respective computer system having program of instructions executable to perform steps in accordance with creating the bundle of loans, some of which correspond to loans brought into being an option embodiment. Between the computer systems are the respective transmitter and receiver systems, enabling the system and method to function as a whole.

An optional step, which can be combined with any other optional step or performed independently, is comparing data in the data structure relating to the lock-triggering prices of loans to at least one market price, to determine for each loan being compared whether the market price has reached a lock-triggering price under the terms of the loan, thereby locking the loan at the lock-triggering price.

Another optional step, which can be combined with any other optional step or performed independently, is entering data in the data structure recording which loans in the data structure are locked.

Still another optional step, which can be combined with any other optional step or performed independently, is selling the security to a buyer.

In an embodiment of the method, the set of loans identified includes at least one pending loan subject to an automatic lock-triggering price.

In another embodiment option rights can be conveyed to their own secondary market, even bundled into a portfolio. Reselling options can be done based on time and uncertainty (volatility), priced according to Black Scholes or other pricing models.

In another embodiment of the method, the set of loans identified includes at least one loan closed at an automatic lock-triggering price of the loan.

Another embodiment that is an efficient implementation can take the form of an enhancement to mortgage processor software, such as that of Genesis, Contour, Ellie Mae, Calyx Point, and others. This approach can permit convenient integration of an option embodiment into other mortgage-related computing, with comparably adaptable versions of software for specialized handling by various participants in the mortgage market, such as mortgage brokers, loan officers, lenders, credit reporting agencies, appraisers, inspectors, etc.) A variation of such an embodiment can be a combination with such as Genesis having access to Ellie Mae's ePASS® Network, which enables essentially instantaneous transactions with lenders, underwriters, and settlement service providers, etc. An embodiment incorporated into a system such as ePASS can thus efficiently integrate an option approach system with: prequalification activities, e.g., minimizing data entry with some automatically populated data fields and standard data flow operations, templates, and optimization features, etc.; origination and tracking, e.g., reducing duplicative data entry, managing document inventory, doing tracking, etc.; analyzing loans in a user's particular system and providing reports daily, monthly, yearly, or otherwise using any of several pre-built reports or tailorable to the user's own custom reporting preferences; contact management (see transmission and receiver systems discussed below), for handling creation of letters and forms, using mail-merge lists, and populating communications with stored loan or application information; HMDA compliance-management; as well as secure transmission of communications such as loan packages or closing documents from your desktop to anyone with an email address. Another technical implementation is a computer-aided method for producing an asset-backed security backed by a multiplicity of loans, the loans being defined by agreements between a multiplicity of borrowers and at least one loan provider. One step of the technical implementation is storing in a computer memory a data structure recording a multiplicity of loans undertaken by a multiplicity of borrowers and at least one loan provider, at least one the loan having an automatic lock-triggering price agreed to govern the price of the loan if a defined market price reaches the lock-triggering price under the terms of the loan. Other steps include updating the data structure to identify closed loans and identifying a set of multiple closed loans recorded in the data structure that are qualified to back a loan-backed security. Another step is forming a loan-backed security by preparing documentation operatively associating the set of multiple loans with the security as the backing for the security.

Yet another technical implementation is a computer-aided method for producing an asset-backed security backed by a multiplicity of loans, the loans being defined by agreements between a multiplicity of borrowers and at least one loan provider. This technical implementation is carried out by a series of steps, including the following. One step is storing in a computer memory a data structure recording a multiplicity of loans undertaken by a multiplicity of borrowers and at least one loan provider, at least one loan having an automatic lock-triggering price agreed to govern the price of the loan if a defined market price reaches the lock-triggering price under the terms of the loan. Additional steps include updating the data structure to identify closed loans; identifying a set of multiple closed loans recorded in the data structure that are qualified to back a loan-backed security, wherein the set of loans includes at least one loan closed at a locked rate; and forming a loan-backed security by preparing documentation operatively associating the set of multiple loans with the security as the backing for the security.

Yet another embodiment is in the context of asset-backed securities, where an option can be used in a manner analogous to an option on a bond. If an interest rate changes to a floor and/or ceiling, the option strikes and there is a right to buy in accordance with the option, e.g., take a discount.

All aspects of loans generated by this means, are intended as embodiments, such as asset-backed securities flowing therefrom. To the extent that the resulting loans more accurately reflect what the customer desired, the loans could have somewhat different characteristics than other loans, such as in refinancing behavior, reflecting upon secondary market (e.g., asset-backed securities) behavior.

In sum, technical implementations have been disclosed directed to computer support (including documentation, tracking, valuation, accounting, etc.) involving a mortgage or other loan interest rate lock or other characteristic option, though other possibilities exist and are exemplified herein. The computer support can include handling inputting data on options and the mortgages and related insurance policies and products and services, analyzing the data to determine the best approach, generating documentation, producing illustrations and reports, accounting, and the like. Thus, data standards can be utilized for efficiently carrying out data handling from data templates structured as a user interface to solicit option data (such as mortgage interest rate option data). Computer support also can extend to generation and reproduction of generally standardized documentation (with customization, e.g., by inserting computed data, in carrying out individual transactions), digital printing, reprinting and copying, etc. Indeed, computer support can reach to many option-related activities, including new or custom or individual product offerings, optimizing product fulfillment, optimizing profits, communications with any or all involved parties (including originators, intermediaries, etc.), tracking, billing and transfers (including electronic funds transfers), protected communications by encryption, records management, real time and batch processing utilizing distributed networks and/or the Internet for communications and web sites, product selection systems, as well as packaging with other mortgage features and related features, budgeting, tax matters, reporting, and coding to track aspects of this approach, other optimization and analysis, secondary market analysis, and even business-to-business referrals for associated products and services, and all with products produced by such processes.

In addition, consider that there can be at least one computer having a program controlling its respective system in implementing its respective activities. The program control can, but need not, govern at least one data processing means arranged for locating option information into memory, the information defining specifications for the option on a loan, the specifications including a trigger for executing the option, the data processing means further can include evaluation means, responsive to the specifications and data for the trigger, the evaluation means capable of signaling execution of the option.

Depending on the embodiment, each of a plurality of computer systems can, but need not, cooperate as a whole to carry out a option and implement a mortgage, carrying through to mortgage-backed securities formed from a mortgage that in turn is formed from exercising the option. Where there is such a cooperating system perspective, any of the computer systems can be viewed as an electronic transmission apparatus, and/or as an electronic receiver apparatus, depending on the communication activity involved in the cooperation of the system as a whole. In handling communications to implement an embodiment herein, the transmission apparatus and/or receiver apparatus can, but need not, include at least one program control means handling communication, e.g., including signaling execution of an option, data for evaluating a trigger for the option, etc. The communications can be carried out with data preferably, but not necessarily, in data sets. The communications can, but need not, be carried out with user interfaces using respective templates to induce communications in a standardized manner.

For this or any aspect of the embodiments herein, there can, but need not, be a computer-readable media tangibly embodying a program of instructions executable by a computer to perform the steps in accordance with other embodiments herein. Further, there can, but need not, be a computer-readable media tangibly embodying a program of instructions executable by a computer to control performance of a computer system carrying out the steps. The media can, but need not, include at least one of a RAM, a ROM, a disk, an ASIC, and a PROM.

In sum, appreciation is requested for the robust range of implications and possibilities flowing from the core teaching herein. The terms, figures, and expressions which have been employed herein are used as terms of teaching and not of limitation, and there is no intention, in the use of such terms and expressions, of excluding equivalents of the features shown and described, or portions thereof, it being recognized that various modifications are possible within the scope of the embodiments contemplated and suggested herein. Further, various embodiments are as described and suggested herein, with the understanding that necessary consequences are being encompassed. Although the disclosure herein has been described with reference to specific embodiments, the disclosures are intended to be illustrative and are not intended to be limiting. Various modifications and applications may occur to those skilled in the art without departing from the true spirit and scope defined in the appended claims.

Thus, although only a few exemplary embodiments have been described in detail above, those skilled in the art will readily appreciate that many modifications are possible in the exemplary embodiments without materially departing from the novel teachings and advantages herein. Accordingly, all such modifications are intended to be included within the scope defined by claims. In the claims, means-plus-function claims are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment fastening wooden parts, a nail and a screw may be equivalent structures.

1. Apparatus for controlling a loan option, the apparatus comprising:
a computer programmed for receiving information into a memory defining specifications for an option on a loan, the specifications including a trigger for executing the option, evaluating the trigger, and if the trigger occurs, signaling execution of the option.

2. The apparatus of claim 1, wherein the computer is programmed for executing the option, if the trigger occurs.

3. The apparatus of claim 1, wherein the trigger is an interest rate for a lock for a mortgage according to the option.

4. The apparatus of claim 3, wherein the interest rate trigger is a floor.

5. The apparatus of claim 3, wherein the interest rate trigger is a ceiling.

6. The apparatus of claim 3, wherein the interest rate trigger comprises a floor and a ceiling.

7. A computer program product having computer code stored thereon, which when run on a computer causes the computer to:
receive information into a memory defining specifications for the option on the loan, the specifications including a trigger for executing the option,
evaluate the trigger, and
if the trigger occurs, signal execution of the option.

8. A system controlling execution of an option on a loan, the system including:
a plurality of computers programmed to cooperate to effectuate an option on a loan, wherein one of the computers is programmed for carrying out the steps of receiving information into a memory defining specifications for the option on the loan, the specifications including a trigger for executing the option, evaluating the trigger, and if the trigger occurs, transmitting a communication signaling execution of the option to another of the computers to control closing of the loan.

9. A computer-readable medium tangibly embodying a program of instructions executable by a computer to perform the steps of receiving information into a memory defining specifications for the option on the loan, the specifications including a trigger for executing the option, evaluating the trigger, and if the trigger occurs, signaling execution of the option.

10. A computer-aided method for carrying out an option on a loan, the method including the steps of:
receiving information into a memory specifications defining the option on the loan, the specifications including a trigger for executing the option;
evaluating the trigger with a computer accessing further data; and
if the trigger is detected, signaling execution of the option.

11. The method of claim 10, wherein the step of receiving is carried out with the trigger being an interest rate for a lock for a mortgage.

12. The method of claim 11, wherein the step of receiving is carried out with the interest rate trigger being a floor.

13. The method of claim 11, wherein the step of receiving is carried out with the interest rate trigger being a ceiling.

14. The method of claim 11, wherein the step of receiving is carried out with the interest rate trigger being comprised of a floor and a ceiling.

15. A system for carrying out a loan option, the system comprising:
a plurality of computers controlled by respective programs, the computers arranged to communicate data structured to identify an option on a loan; and
means for effectuating the option to control closing of the loan.

16. The system of claim 15, further including means for computing a secondary market characteristic related to the option.

17. A computer system for implementing a loan, the system including:
a database of data relating to mortgage loan applications, the database including an indicator of an application status other than a lock status and a float status; and
a program accessing the database to analyze the status information in carrying out closings of some of the loans.

18. The computer system of claim 17, wherein the indicator indicates an option status.

19. The computer system of claim 17, wherein the program uses shock analysis on said application status loan applications.

20. The computer system of claim 18, wherein said database includes one or both of a floor and a ceiling in association with said option status.

21. A template for associating data indicating a price lock with data indicating a customer identity, the template comprising:
a first data field configured to receive an entry of data indicating a future lock-triggering price for a contemplated transaction;
a prompt soliciting a potential customer to enter data indicating a future lock-triggering price in the first field; and
a second field configured to receive an entry of data indicating the identity of a potential customer contemplating the transaction.

22. A data structure comprising:
data indicating a future lock-triggering price for a contemplated transaction; and
data indicating a potential customer associated with the contemplated transaction.

23. The data structure of claim 22, recorded on a computer readable medium.

24. A data structure comprising:
data indicating a desired future lock-triggering price for one or more contemplated transactions; and
data indicating the monetary value of the one or more contemplated transactions.

25. A database recorded on a computer readable medium, the database comprising a multiplicity of records, at least one of the records comprising:
a desired future lock-triggering price for a contemplated transaction; and
a monetary value representing the scale of the contemplated transaction.

26. A computer system programmed for:
eliciting information regarding a potential customer who contemplates carrying out a financial transaction;
a eliciting a future lock-triggering price contemplated by the customer for the financial transaction;
determining whether the lock-triggering price is available; and
a if and when the lock-triggering price becomes available, communicating that the lock has been triggered.

27. The computer system of claim 26, further programmed for evaluating the information and lock-triggering price to determine whether the financial transaction is acceptable to a seller that contemplates participating in the financial transaction.

28. A computer system programmed for:
eliciting information regarding a potential customer who contemplates carrying out a financial transaction;
eliciting a future lock-triggering price contemplated by the potential customer for the financial transaction; and
communicating the future lock-triggering price to a potential supplier of the financial transaction.

29. A data structure comprising a database of records, each record constituting data documenting a pending loan application, the data structure defining a pool of pending loan applications, each configured for backing a loan-backed security, wherein at least one application in the pool identifies a future lock-triggering price at which the loan will be locked if the triggering price becomes available.

30. A computer system comprising the database of claim 25 and a computer processor programmed for:
reading the associated lock-triggering prices in the database,
searching for prices offered by sellers of the transactions corresponding to the lock-triggering prices,
when a price offered by a seller of the transactions corresponding to one or more of the lock-triggering prices is located, updating the records in the database to indicate that the rate is locked.

31. A self-executing price lock agreement usable by a buyer and seller to establish the price of a future transaction that has a fluctuating market price, comprising:
a provision specifying a future lock-triggering price for the transaction; and
a provision that the seller automatically agrees to accept the specified future lock-triggering price as the negotiated price of the future transaction, if in the future the market price reaches the future lock-triggering price.

32. A method for establishing a price lock for a future transaction subject to market price fluctuations, the method comprising:
establishing a future lock-triggering price and a lock price for the transaction, wherein the lock price is the same as or different from the future lock-triggering price;
agreeing that if in the future the market price for the transaction reaches the future lock-triggering price, the price for the transaction shall be the lock price.

33. A machine for establishing a price lock for a future transaction subject to market price fluctuations, the machine comprising:
means for establishing a future lock-triggering price for the transaction;
means for determining in the future whether the market price for the transaction has reached the future lock-triggering price, and
means responsive to the determining means for communicating that the market price for the transaction has reached the future lock-triggering price.

34. A machine for establishing a price lock for a future transaction subject to market price fluctuations, the machine comprising:
a data field for entering a future lock-triggering price for the transaction;
a market price monitor programmed for determining in the future whether the market price for the transaction has reached the future lock-triggering price, and
an output for communicating data indicating that the market price for the transaction has reached the future lock-triggering price.

35. A method for implementing a future rate lock for a financial transaction that has a market rate, the method comprising:
providing a digital computer apparatus comprising a processor for receiving input data, processing the input data to produce output data, and outputting the output data; a memory operatively connected to the processor for storing and retrieving machine-readable data input to and output from the processor; and a program operatively connected to the processor to form circuitry in the processor for controlling the processor to receive the input data and to produce and store in the memory the output data;
inputting data to the processor identifying the customer and a proposed future triggering rate which the customer proposes to lock in if the market rate reaches the proposed triggering rate;
inputting data to the processor identifying the current market rate at which the financial transaction is being undertaken;
a comparing with the processor the proposed future triggering rate to the current market rate; and
if the current market rate reaches the future triggering rate, the processor generating as output data in the memory a record indicating that the proposed future triggering rate has been locked.

36. A method for calculating risk exposure resulting from accepting a portfolio of future rate locks for financial transactions triggered by the market reaching a predetermined trigger rate, the method comprising:
providing a digital computer apparatus comprising a processor for receiving input data, processing the input data to produce output data, and outputting the output data; a memory operatively connected to the processor for storing and retrieving machine-readable data input to and output from the processor; and a program operatively connected to the processor to form circuitry in the processor for controlling the processor to receive the input data and to produce and store in the memory the output data;
inputting to the processor the gross volume of loans in a portfolio locked in at a particular lock rate;
a inputting to the processor a pull through rate for the portfolio;
computing with the processor the product of the gross volume of loans and the pull through rate, thus determining the estimated net volume of loans that will be closed at the particular lock rate; and
a outputting to the memory the estimated net volume of loans that will be closed at the particular lock rate.

37. A method for hedging the risk exposure resulting from accepting a portfolio of future rate locks for financial transactions triggered by the market reaching a predetermined trigger rate, the method comprising:
providing a digital computer apparatus comprising a processor for receiving input data, processing the input data to produce output data, and outputting the output data; a memory operatively connected to the processor for storing and retrieving machine-readable data input to and output from the processor; and a program operatively connected to the processor to form circuitry in the processor for controlling the processor to receive the input data and to produce and store in the memory the output data;
inputting to the processor the estimated net volume of loans in a portfolio that will be closed at a particular lock rate;
inputting to the processor the volume of loans that are fully hedged;
computing with the processor the difference between the net volume of loans that will be closed and the volume of loans that are fully hedged, producing as output data the amount of hedging transactions to properly hedge the portfolio; and
storing the output data in the memory.

38. A computer-aided method for producing an asset-backed security backed by a multiplicity of loans, the loans being defined by agreements between a multiplicity of borrowers and at least one loan provider, the method comprising:
A. storing in a computer memory a data structure recording a multiplicity of loans undertaken by a multiplicity of borrowers and at least one loan provider, the data structure including for at least one loan data corresponding to an automatic lock-triggering price agreed to govern the price of the loan if a defined market price reaches the lock-triggering price under the terms of the loan;
B. updating the data structure to identify closed loans;
C. identifying a set of multiple closed loans recorded in the data structure that are qualified to back a loan-backed security, and
D. forming a loan-backed security by preparing documentation operatively associating the set of multiple loans with the security as the backing for the security.

39. The method of claim 38, further comprising comparing data in the data structure relating to the lock-triggering prices of loans to at least one market price, to determine for each loan being compared whether the market price has reached a lock-triggering price under the terms of the loan, thereby locking the loan.

40. The method of claim 38, further comprising entering data in the data structure recording which loans in the data structure are locked.

41. The method of claim 38, further comprising selling the security to a buyer.

42. The method of claim 38, wherein the set of loans identified includes at least one loan subject to an automatic lock-triggering price.

43. The method of claim 38, wherein the set of loans identified includes at least one loan closed at an automatic lock-triggering price of the loan.

44. A computer-aided method for producing an asset-backed security backed by a multiplicity of loans, the loans being defined by agreements between a multiplicity of borrowers and at least one loan provider, the method comprising:
A. storing in a computer memory a data structure recording a multiplicity of loans undertaken by a multiplicity of borrowers and at least one loan provider, at least one the loan having an automatic lock-triggering price agreed to govern the price of the loan if a defined market price reaches the lock-triggering price under the terms of the loan;
B. updating the data structure to identify closed loans;
C. identifying a set of multiple closed loans recorded in the data structure that are qualified to back a loan-backed security; and
D. forming a loan-backed security by preparing documentation operatively associating the set of multiple loans with the security as the backing for the security.

45. A computer-aided method for producing an asset-backed security backed by a multiplicity of loans, the loans being defined by agreements between a multiplicity of borrowers and at least one loan provider, the method comprising:
A. storing in a computer memory a data structure recording a multiplicity of loans undertaken by a multiplicity of borrowers and at least one loan provider, at least one the loan having an automatic lock-triggering price agreed to govern the price of the loan if a defined market price reaches the lock-triggering price under the terms of the loan;
B. updating the data structure to identify closed loans;
C. identifying a set of multiple closed loans recorded in the data structure that are qualified to back a loan-backed security, wherein the set of loans includes at least one loan closed at a locked rate; and
D. forming a loan-backed security by preparing documentation operatively associating the set of multiple loans with the security as the backing for the security.
